(19) United States
(12) Patent Application Publication
(10) Pub. No.: US 2005/0079919 A1
(43) Pub. Date: Apr. 14, 2005

(54) Molding method for geared member with boss and geared member with boss

(75) Inventors: Kazuto Kobayashi, Kanagawa (JP); Isao Shintou, Kanagawa (JP)

Correspondence Address: SUGHRUE MION,PLLC, 2100 PENNSYLVANIA AVENUE N.W., SUITE 800, WASHINGTON, DC, 20037, US

(73) Assignee: NSK LTD.

(21) Appl. No.: 10/958,334

(22) Filed: Oct. 6, 2004

(30) Foreign Application Priority Data
Oct. 14, 2003 (JP) P.2003-353577

(51) Int. Cl. F16D 3/18

(52) U.S. Cl. 464/158

(57) ABSTRACT

A method for molding a geared member with a boss, includes: (a) molding a boss portion by performing a backward extruding process for one end of a predetermined raw material; (b) molding a chamfer portion by performing a forward extruding process for the other end of said raw material; and (c) molding a gearing portion in which a plurality of teeth continuously from the chamfer portion toward the one end are molded by performing the forward extruding process for an extrusion residual area of the raw material having passed through the step (a) and (b). The predetermined raw material is constructed as the geared member with the boss in which the boss portion is molded at the one end and the gearing portion is molded continuously from the chamfer portion at the other end by passing through the steps (a)-(c)

### BACKGROUND OF THE INVENTION

1. Field of the Invention

The present invention relates to a method for molding a geared member with a boss that is applicable to various kinds of couplings (e.g., a rigid coupling, a flexible joint, a universal joint and an Oldham's coupling for coupling the drive shaft and the driven shaft.

2. Background Art

Conventionally, various types of geared member with boss are applied to a transmission for automobile, for example. As one example, FIGS. 2A and 2B show a geared member with a boss 106 in which a boss portion 102 is molded at one end of a flange 100 and a gearing portion 104 is molded at the other end. On the gearing portion 104 of this geared member with boss 106, a plurality of convex teeth 104a are molded at a predetermined pitch along the circumferential direction. To mold the gearing portion 104 (geared member with boss 106) having the plurality of teeth 104a, the molding methods are well known as disclosed in patent documents 1 and 2, for example.

With a molding method of JP-A-2-129304, a plurality of teeth 104a are molded by sintering and forging. More specifically, metal powder is compression molded within a mold while being sintered in the atmosphere of non-oxidizing gas, and sized into a predetermined toothed shape by cold forging.

With a molding method of JP-A-6-246388, a step portion is provided on a mandrel for use in cold forging, and a partial molding pressure at the time of cold forging is directly applied from the step portion to the raw material, so that the raw material is sized into an intended toothed shape.

By the way, in the geared member with boss 106 as described above, a tooth end portion P (an extended end portion P of the plurality of teeth 104a extending from a flange 100 to the other side) of the gearing portion 104 may be chamfered. In this case, if a chamfer is provided on the tooth end portion P of the gearing portion 104 by the conventional molding method, an excessive pressure must be exerted within a mold to produce the chamfer shape, in which there was a fear that the mold might be damaged by the molding pressure. Thus, conventionally, after the geared member with boss 106 as shown in FIGS. 2A and 2B was molded by cold forging, a mechanical process (e.g., cutting, polishing, etc.) was separately performed for the tooth end portion P of the gearing portion 104.

However, if an additional operation process for chamfering is provided, separately from a series of operation processes by cold forging, the availability factor is lower due to a difference between operation processes, or the working load is increased, resulting in lower manufacturing efficiency of the geared member with boss. Moreover, the plan and equipment investment for chamfering are additionally required, increasing the manufacturing cost of the geared member with boss.

### SUMMARY OF THE INVENTION

This invention has been achieved to solve the above-mentioned problems, and it is an object of the invention to provide a molding method for molding a geared member with a boss at a high manufacturing efficiency and a low price by providing the chamfer on the gear end portion of the gearing portion in a series of operation processes without providing an additional operation process for chamfering.

To achieve the object, the invention provides a method for molding a geared member with a boss, including: (a) molding a boss portion by performing a backward extruding process for one end of a predetermined raw material; (b) molding a chamfer portion by performing a forward extruding process for the other end of said raw material; and (c) molding a gearing portion in which a plurality of teeth continuously from the chamfer portion toward the one end are molded by performing the forward extruding process for an extrusion residual area of the raw material having passed through the steps (a) and (b); wherein the predetermined raw material is constructed as the geared member with the boss in which the boss portion is molded at the one end and the gearing portion is molded continuously from the chamfer portion at the other end by passing through the steps (a)-(c).

Preferably, the chamfer portion molded at the other end of the raw material in the step (b) can be set to any curvature.

Preferably, the method further includes: (d) sizing the gearing portion having a plurality of teeth into a predetermined shape by compression molding an extrusion residual flange of the raw material.

Preferably, the steps (a) and (b) are performed at the same time.

The invention provides a geared member with a boss, including: a boss portion molded at one end; and a gearing portion at the other end, the gearing portion having a chamfer portion and being molded continuously from the chamfer portion; wherein the gearing portion has a plurality of teeth molded continuously with from the chamfer portion toward the one end; the boss portion is molded by performing a backward extruding process for one end of a predetermined raw material; the chamfer portion is molded by performing a forward extruding process for the other end of the raw material; the gearing portion in which a plurality of teeth are molded continuously from the chamfer portion toward the one end by performing the forward extruding process for an extrusion residual area of the raw material; and the predetermined raw material is constructed as the geared member with the boss.

Preferably, the chamfer portion molded at the other end of the raw material is set to any curvature.

Preferably, an extrusion residual flange of the raw material is compression molded so that the boss portion is molded at the one end side of the flange; and the gearing portion sized into a predetermined shape is molded at the other end side of the flange.

### BRIEF DESCRIPTION OF THE DRAWINGS

The present invention may be more readily described with reference to the accompanying drawings:

FIGS. 1A to 1D are views showing a molding process of a geared member with a boss according to one embodiment of the present invention, FIG. 1E is a perspective view of the geared member with boss molded through the molding process of FIGS. 1A to 1D, and FIG. 1F is a side view of the geared member with boss.

FIG. 2A is a perspective view of the conventional geared member with boss, and FIG. 2B is a side view of the conventional geared member with boss.

### DETAILED DESCRIPTION OF THE PREFERRED EMBODIMENTS

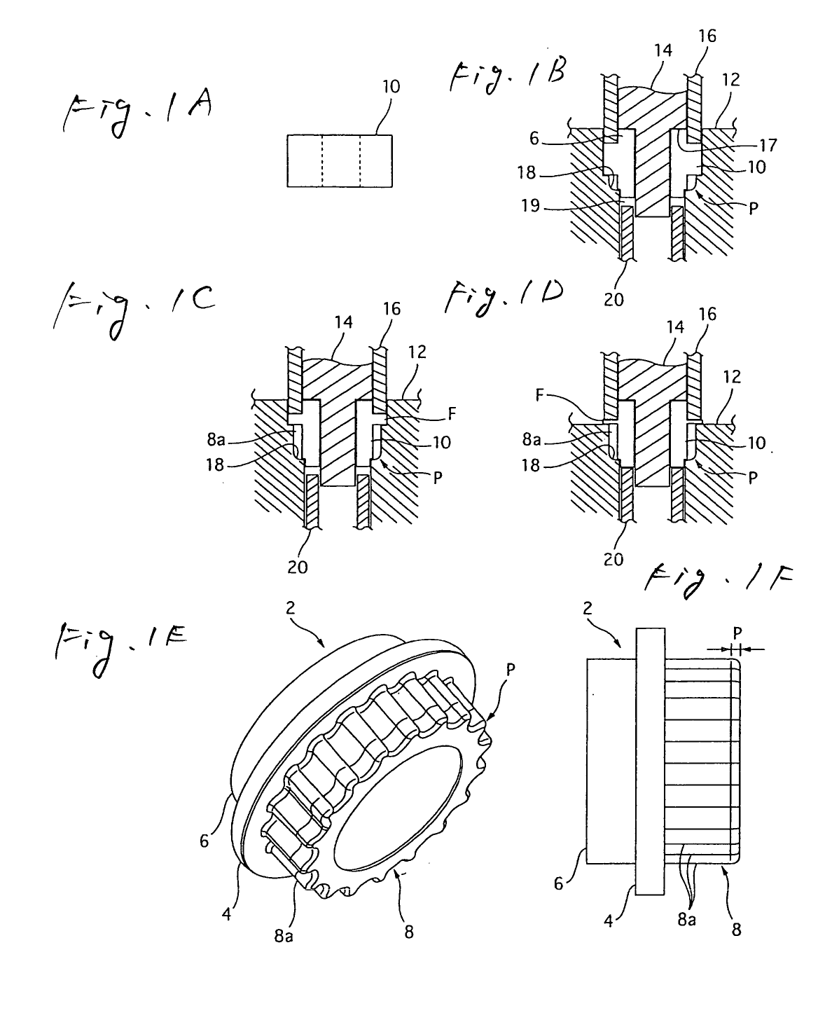

Referring to FIG. 1, a method for molding a geared member with a boss according to one embodiment of the present invention will be described below.

As shown in FIGS. 1E and 1F, the geared member with boss 2 according to this embodiment comprises a boss portion 6 molded at one end of a flange 4, and a gearing portion 8 molded continuously from a toothed chamfer portion P at the other end. The gearing portion 8 has a plurality of teeth 8a molded continuously from the toothed chamfer portion P to one end. The toothed chamfer portion P is molded at a tooth end portion of the plurality of teeth 8a extending from the flange 4 to the other end.

The geared member with boss 2 is applicable to various kinds of couplings (e.g. a rigid coupling, a flexible joint, a universal joint and an Oldham's coupling for coupling the drive shaft and the driven shaft, for which the plurality of teeth 8a are molded continuously at a predetermined pitch along the circumferential direction around the outer circumference of the gearing portion 8.

In this case, the gearing portion 8 is sized into any geometry and the toothed chamfer portion P set to any curvature in accordance with the kind and geometry of the coupling to apply the geared member with boss 2.

A method for molding the geared member with boss 2 according to this embodiment will be described below by way of example.

First of all, a hollow cylindrical metallic raw material 10 is prepared as the raw material for the geared member with boss 2, as shown in FIG. 1A. Herein, the molding method by cold forging is supposed as one example. The materials are not specifically limited, because the metal material is optimally selected in accordance with the use purposes or use environment of the geared member with boss 2.

As shown in FIG. 1B, the metallic raw material 10 is set within a die 12 of predetermined shape, hermetically held by a mandrel 14, and compressed by a punch 16. At this time, one end of the metallic raw material 10 is flowed into the inside of the punch 16 due to a compressive force of the punch 16 (backward extrusion), while the other end of the metallic raw material 10 is flowed in a direction to a toothed step portion 18 of the die 12 (forward extrusion). That is, employing a molding force for molding the boss portion 6, the toothed chamfer portion P provided on its reaction force side is molded at the same time. Since the toothed step portion 18 of the die 12 has a curved face, the chamfer portion P having a predetermined curvature is molded at the other end of the metallic raw material 10 extruded forwards toward the step portion 18 (see FIGS. 1E and 1F). In this case, the curvature of the chamfer portion P may be arbitrarily set in accordance with a curved state (degree of curvature) of the step portion 18 making a curved surface. For example, if the degree of curvature is reduced, the chamfer portion P having smaller curvature is molded. On the contrary, if the degree of curvature is increased, the chamfer portion P, having large curvature is molded.

Then, the material is further extruded and flowed into a space 19 provided on the front side, with an end face of a backward extruding portion in contact with a step portion 17 of the mandrel 14, whereby the length of the boss portion 6 is regulated, and the material is further filled (replenished) into the toothed step portion 18.

Subsequently, the gearing portion 8 (see FIGS. 1E and 1F) having the plurality of teeth 8a molded continuously from the chamfer portion P to one end is molded by further performing the forward extruding process for an extrusion residual area of the metallic raw material 10, using the punch 16, as shown in FIG. 1C.

And the gearing portion 8 having the plurality of teeth 8a is sized into a predetermined shape by compressing and molding an extrusion residual flange F (a portion becoming the flange 4 after molding) of the metallic raw material 10, using the punch 16, as shown in FIG. 1D. The length size of each tooth 8a of the gearing portion 8 is decided depending on the sizing amount at this time. The sizing amount is arbitrarily set in accordance with the kind or geometry of coupling applied to the geared member with boss 2, and not specifically limited here.

Also, the length size of the boss portion 6 may be simply increased or decreased by a desired amount if a hole (specifically not shown) having a slightly smaller diameter than the deddendum of each tooth 8a of the gearing portion 8 is formed in the mandrel 14, and an excess thickness on one end of the metallic raw material 10 is flowed into the hole (backward extrusion using the punch), for example.

Through the molding process, the geared member with boss 2 comprising the boss portion 6 molded at one end of the flange 4 and the gearing portion 8 in which the plurality of teeth 8s is molded continuously from the chamfer portion P at the other end is molded, as shown in FIGS. 1E and 1F. The completed geared member with boss 2 is ejected from the die 12 by a knockout 20.

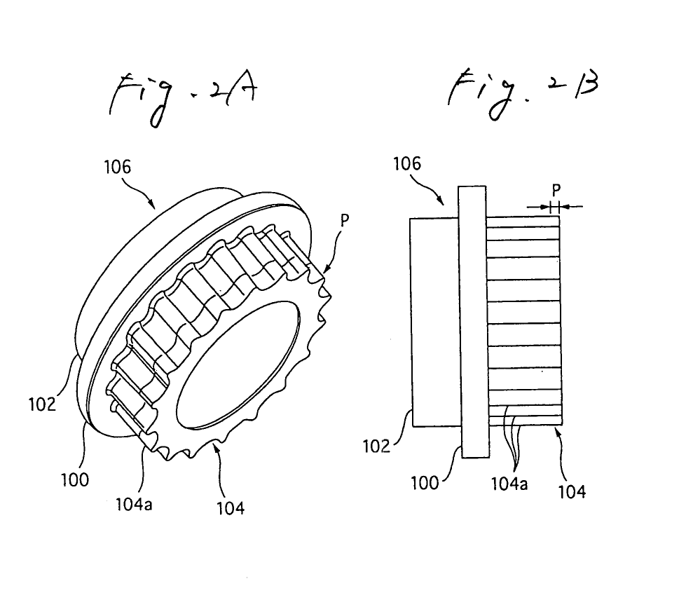

With the prior art, if the geared member with boss 2 of this embodiment is molded up to the chamfer portion P at the same time of extruding the gear, an excessive molding pressure must be applied to the inside of the mold to produce the shape of the chamfer portion (gear end portion) P, whereby there was a fear that the mold might be damaged depending on the magnitude of molding pressure. Thus, conventionally, after the geared member with boss as shown in FIGS. 2A and 2B was molded by cold forging, a mechanical process (e.g., cutting, polishing, etc.) was separately performed for the tooth end portion of the gearing portion. However, if an additional operation process for chamfering is provided, separately from a series of operation processes by cold forging, the availability factor is lower due to a difference between operation processes, or the working load is increased, resulting in lower manufacturing efficiency of the geared member with boss. Moreover, the plan and equipment investment for chamfering are additionally required, increasing the manufacturing cost of the geared member with boss.

However, with the above molding method of this embodiment, the chamfer portion P is molded, at the same time of molding the boss portion 6. Therefore, the chamfer portion P is molded in the tooth end portion of the gearing portion 8 in the series of processes (a series of cold forging processes in this embodiment) without need for providing the additional process for molding the chamfer portion P. Consequently, the manufacturing efficiency is higher through the series of operation processes than conventionally, and the manufacturing cost of the geared member with boss 2 is reduced by simplifying the operation processes.

Also, with the molding method of this embodiment, the outer shape of the plurality of teeth 8a of the gearing portion 8 can be arbitrarily set. For example, the appearance shape of each tooth 8a can be made a smooth R by setting the curvature of each tooth 8a to be matched with the curvature of the chamfer portion P, whereby the geared member with boss 2 is realized in accordance with the kind or geometry of coupling. In this case, it is possible to smoothly fit the gearing portion 8 (the plurality of teeth 8a) of the geared member with boss 2 with the coupling.

According to the invention, it is possible to provide a molding method for molding a geared member with a boss at a high manufacturing efficiency and a low price by providing the chamfer on the gear end portion of the gearing portion in a series of operation processes without providing an additional operation process for chamfering.

The present invention is applicable to ships or aircrafts, or various kinds of machines with the couplings (e.g., a rigid coupling, a flexible joint, a universal joint and an Oldham's coupling for coupling the drive shaft and the driven shaft) incorporated.

1. A method for molding a geared member with a boss, comprising:
(a) molding a boss portion by performing a backward extruding process for one end of a predetermined raw material;
(b) molding a chamfer portion by performing a forward extruding process for the other end of said raw material; and
(c) molding a gearing portion in which a plurality of teeth continuously from the chamfer portion toward the one end are molded by performing the forward extruding process for an extrusion residual area of the raw material having passed through the steps (a) and (b);
wherein the predetermined raw material is constructed as the geared member with the boss in which the boss portion is molded at the one end and the gearing portion is molded continuously from the chamfer portion at the other end by passing through the steps (a)-(c).

2. The method for molding the geared member with the boss according to claim 1,
wherein the chamfer portion molded at the other end of the raw material in the step (b) can be set to any curvature.

3. The method for molding the geared member with the boss according to claim 1, further comprising:
(d) sizing the gearing portion having a plurality of teeth into a predetermined shape by compression molding an extrusion residual flange of the raw material.

4. The method for molding the geared member with the boss according to claim 1,
wherein the steps (a) and (b) are performed at the same time.

5. A geared member with a boss, comprising:
a boss portion molded at one end; and
a gearing portion at the other end, the gearing portion having a chamfer portion and being molded continuously from the chamfer portion;
wherein the gearing portion has a plurality of teeth molded continuously with from the chamfer portion toward the one end;
the boss portion is molded by performing a backward extruding process for one end of a predetermined raw material;
the chamfer portion is molded by performing a forward extruding process for the other end of the raw material;
the gearing portion in which a plurality of teeth are molded continuously from the chamfer portion toward the one end by performing the forward extruding process for an extrusion residual area of the raw material; and
the predetermined raw material is constructed as the geared member with the boss.

6. The geared member with a boss according to claim 5,
wherein the chamfer portion molded at the other end of the raw material is set to any curvature.

7. The geared member with a boss according to claim 5,
wherein an extrusion residual flange of the raw material is compression molded so that the boss portion is molded at the one end side of the flange; and
the gearing portion sized into a predetermined shape is molded at the other end side of the flange.
